(19) United States
(12) Patent Application Publication
(10) Pub. No.: US 2021/0192296 A1
(43) Pub. Date: Jun. 24, 2021

(54) DATA DE-IDENTIFICATION METHOD AND APPARATUS

(71) Applicant: Electronics and Telecommunications Research Institute, Daejeon (KR)

(72) Inventors: Nack Woo KIM, Gwangju (KR); Byung-Tak LEE, Suwon-si (KR); Jungi LEE, Gwangju (KR); Hyun Yong LEE, Gwangju (KR)

(73) Assignee: Electronics and Telecommunications Research Institute, Daejeon (KR)

(21) Appl. No.: 17/131,039

(22) Filed: Dec. 22, 2020

(30) Foreign Application Priority Data
Dec. 23, 2019 (KR) 10-2019-0172989

(51) Int. Cl. G06K 9/62; G06N 3/08

(52) U.S. Cl. CPC G06K 9/6296; G06N 3/08; G06K 9/6268; G06K 9/6232

(57) ABSTRACT

A data de-identification method and an apparatus performing the data de-identification method are disclosed. The data de-identification method includes receiving identification data including a plurality of input feature vectors and generating a graph neural network (GNN) model including a plurality of nodes each having a value corresponding to each of the input feature vectors, determining a de-identification vector to which a correlation between the nodes is applied from the input feature vectors through the GNN model, and extracting an output feature vector by grouping values in each of the input feature vectors using the GNN model.

### CROSS-REFERENCE TO RELATED APPLICATION(S)

This application claims the priority benefit of Korean Patent Application No. 10-2019-0172989 filed on Dec. 23, 2019, in the Korean Intellectual Property Office, the disclosure of which is incorporated herein by reference for all purposes.

### BACKGROUND

### 1. Field

One or more example embodiments relate to a data de-identification method and an apparatus performing the data de-identification method, and more particularly, to a method and apparatus for de-identifying data by grouping identification data using a graph neural network (GNN) model.

### 2. Description of Related Art

A massive amount of data obtained from various fields is distributed online and offline. The distribution of such big data may, however, inevitably cause a side effect including, for example, leaks of personal information. Data de-identification is thus emerging as an important technology in the distribution of big data.

An existing de-identification method such as masking, substitution, semi-identification, and categorization may de-identify data. However, using such a method, a relationship between sets of data may tend to be disregarded. For example, in a case in which an address field of each set of data is substituted or categorized to be de-identified to de-identify identification data including a personal address and a power consumption amount, it may not be easy to analyze a correlation between sets of data having addresses close to each other.

That is, using such an existing method, it is not easy to analyze a correlation between sets of data having similar addresses. Thus, there is a desire for a technology that may apply a data correlation while de-identifying data.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

An aspect provides a method and apparatus that may analyze a correlation between sets of data by providing a de-identification vector such that an analysis of de-identified data is performed in a similar way as an analysis of a correlation between sets of previous identification (or identified) data.

Another aspect provides a method and apparatus that may protect personal information required to be protected when distributing data by de-identifying personal information included in identification data.

According to an example embodiment, there is provided a data de-identification method including receiving identification data including a plurality of input feature vectors and generating a graph neural network (GNN) model including a plurality of nodes each having a value corresponding to each of the input feature vectors, determining a de-identification vector to which a correlation between the nodes is applied from the input feature vectors through the GNN model, and extracting an output feature vector by grouping values in each of the input feature vectors using the GNN model.

The generating of the GNN model may include determining the GNN model including an initial matrix corresponding to an initial graph including nodes generated based on the identification data and an edge to which a correlation between the nodes is applied, and including a weight matrix.

The determining of the de-identification vector may include generating the de-identification vector by performing an operation on an input feature vector including personal information or the correlation between the nodes among the input feature vectors, with the initial matrix and the weight matrix of the GNN model.

The extracting of the output feature vector may include generating the output feature vector by grouping the values respectively corresponding to the nodes in each of the input feature vectors by performing an operation on the input feature vectors with the initial matrix and the weight matrix of the GNN model.

The data de-identification method may further include substituting the output feature vector with the de-identification vector to which the correlation between the nodes is applied.

The data de-identification method may further include classifying the nodes based on the substituted output feature vector.

The data de-identification method may further include updating the weight matrix included in the GNN model to minimize the number of groups in the grouping of the values in each of the input feature vectors.

According to another example embodiment, there is provided a data de-identification apparatus including a processor. The processor may receive identification data including a plurality of input feature vectors, generate a GNN model including a plurality of nodes each having a value corresponding to each of the input feature values, determine a de-identification vector to which a correlation between the nodes is applied from the input feature vectors through the GNN model, and extract an output feature vector by grouping values in each of the input feature vectors using the GNN model.

The processor may determine the GNN model including an initial matrix corresponding to an initial graph including nodes generated based on the identification data and an edge to which a correlation between the nodes is applied, and including a weight matrix.

The processor may generate the de-identification vector by performing an operation on an input feature vector including personal information or the correlation between the nodes among the input feature vectors, with the initial matrix and the weight matrix of the GNN model.

The processor may generate the output feature vector by grouping the values respectively corresponding to the nodes in each of the input feature vectors by performing an operation on the input feature vectors with the initial matrix and the weight matrix of the GNN model.

The processor may substitute the output feature vector with the de-identification vector to which the correlation between the nodes is applied.

The processor may classify the nodes based on the substituted output feature vector.

The processor may update the weight matrix included in the GNN model to minimize the number of groups in the grouping of the values in each of the input feature vectors.

Other features and aspects will be apparent from the following detailed description, the drawings, and the claims.

### BRIEF DESCRIPTION OF THE DRAWINGS

These and/or other aspects, features, and advantages of the present disclosure will become apparent and more readily appreciated from the following description of example embodiments, taken in conjunction with the accompanying drawings of which:

FIG. 1 is a diagram illustrating an example of a data de-identification apparatus according to an example embodiment;

FIG. 2 is a diagram illustrating an example of generating an initial matrix based on identification data according to an example embodiment;

FIG. 3 is a diagram illustrating an example of extracting an output feature vector using an input feature vector according to an example embodiment;

FIG. 4 is a diagram illustrating an example of classifying values in an output feature vector using a de-identification vector to which a correlation is applied according to an example embodiment;

FIG. 5 is a diagram illustrating an example of grouping nodes of a graph neural network (GNN) model according to an example embodiment; and

FIG. 6 is a flowchart illustrating an example of a data de-identification method according to an example embodiment.

### DETAILED DESCRIPTION

Hereinafter, example embodiments will be described in detail with reference to the accompanying drawings. However, various alterations and modifications may be made to the example embodiments. Here, examples are not construed as being limited to the present disclosure and should be understood to include all changes, equivalents, and replacements within the idea and the technical scope of the disclosure.

The terminology used herein is for describing various examples only and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof. Although terms such as “first,” “second,” and “third” may be used herein to describe various members, components, regions, layers, or sections, these members, components, regions, layers, or sections are not to be limited by these terms. Thus, a first member, component, region, layer, or section referred to in examples described herein may also be referred to as a second member, component, region, layer, or section without departing from the teachings of the examples. As used herein, the term “and/or” includes any one and any combination of any two or more of the associated listed items.

Unless otherwise defined, all terms, including technical and scientific terms, used herein have the same meaning as commonly understood by one of ordinary skill in the art to which this disclosure pertains and based on an understanding of the disclosure of the present application. Terms, such as those defined in commonly used dictionaries, are to be interpreted as having a meaning that is consistent with their meaning in the context of the relevant art and the disclosure of the present application and are not to be interpreted in an idealized or overly formal sense unless expressly so defined herein.

Hereinafter, example embodiments will be described in detail with reference to the accompanying drawings, and like reference numerals in the drawings refer to like elements throughout. Also, in the description of examples, detailed description of well-known related structures or functions will be omitted when it is deemed that such description will cause ambiguous interpretation of the present disclosure.

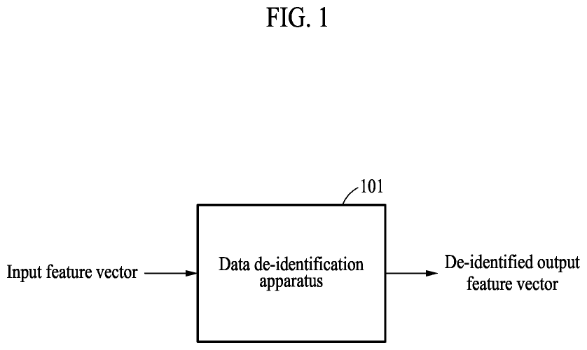

FIG. 1 is a diagram illustrating an example of a data de-identification apparatus according to an example embodiment.

Referring to FIG. 1, a data de-identification apparatus 101 may include a processor, and the processor included in the data de-identification apparatus 101 may perform a data de-identification method described herein.

As illustrated in FIG. 1, the data de-identification apparatus 101 may receive identification data including an input feature vector. The data de-identification apparatus 101 may extract an output feature vector from the input feature vector through a graph neural network (GNN) model.

The input feature vector described herein may indicate a value possessed by each of nodes included in the GNN model with respect to one of fields associated with personal information. For example, in a case in which there is identification data in which a power consumption amount per household, a water consumption amount per household, and a gas consumption amount per household are described, each node may indicate each household, and each field associated with personal information may indicate each of the power consumption amount, the water consumption amount, and the gas consumption amount. For example, one of a plurality of input feature vectors may indicate a power consumption amount of each household.

The output feature vector described herein may indicate a vector obtained by grouping values in the input feature vector by the data de-identification apparatus 101. For example, in a case in which five input feature vectors include a power consumption amount of each of households corresponding to home addresses, an output feature vector extracted by the data de-identification apparatus 101 may be a vector obtained by grouping values of households among the households that have a similar power consumption amount.

De-identification refers to de-identifying identification data which is identifiable data. For example, when de-identifying identification data including, for example, addresses, ages, and contact numbers, such data including the addresses, the ages, and the contact numbers may be substituted with an unidentifiable character string.

The GNN may be one of neural network methods, which uses a graph. The GNN model described herein may include, as its components, an initial matrix corresponding to a node and edge-based graph and an arbitrarily generated weight matrix.

The data de-identification apparatus 101 may generate an initial graph including a node and an edge based on the identification data. The edge may be generated by applying a correlation between nodes (or simply referred to as a node correlation hereinafter). That is, the edge may be present when there is a node correlation. Each node may have a value with respect to each input feature vector.

The data de-identification apparatus 101 may generate the initial matrix corresponding to the initial graph by setting a value “1” when there is an edge between two nodes in the initial graph and setting a value “0” when there is no edge.

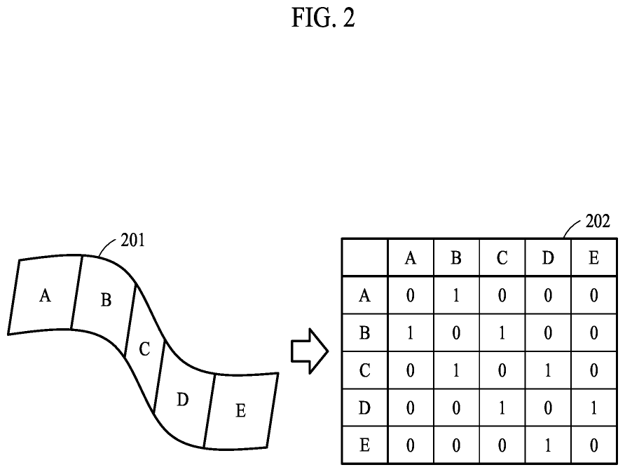

FIG. 2 is a diagram illustrating an example of generating an initial matrix based on identification data according to an example embodiment.

Referring to FIG. 2, an initial graph 201 includes successive nodes. For example, as illustrated, each of A, B, C, D, and E indicates a single node, and there is an edge because the nodes are successive in sequential order of A, B, C, D, and E.

For example, in a case in which there are N nodes, a data de-identification apparatus may generate an initial matrix, (e.g., an initial matrix 202 illustrated in FIG. 2) of a size of N×N in which 1 indicates the presence of an edge between two nodes and 0 indicates the absence of the edge. The initial matrix described herein may be a matrix to which a node correlation is applied.

For example, as illustrated in FIG. 2, there may be five nodes A, B, C, D, and E, and there may be an edge between A and B, an edge between B and C, an edge between C and D, and an edge between D and E. In this example, the data de-identification apparatus may set, to be 1, a value of column B in row A, a value of column A in row B, and a value of column B in row C.

The data de-identification apparatus may determine an input matrix from identification data based on the number of nodes and the number of input feature vectors. For example, in a case in which there are N nodes and D input feature vectors in identification data, the data de-identification apparatus may generate an input matrix of a size of N×D.

For example, in a case in which there are an input feature vector including a water consumption amount per household, an input feature vector including a power consumption amount per household, and an input feature vector including an address of each household, each node may include an address, a water consumption amount, and a power consumption amount of each household. In this example, in a case in which there are five households, an input matrix of a size of 5×3 may be generated.

The data de-identification apparatus may train a GNN model by performing an operation with the input matrix, the initial matrix, and weight matrices. Through this, the data de-identification apparatus may generate an output matrix based on the number of output feature vectors and the number of nodes. The output matrix may include a de-identification vector and an output feature vector obtained by grouping values in each of input feature vectors.

According to an example embodiment, the data de-identification apparatus may receive identification data including a plurality of input feature vectors and an identification vector, and generate a GNN model including an initial matrix that is based on the received identification data, and a weight matrix.

The data de-identification apparatus may determine a de-identification vector from the identification data through the GNN model. The de-identification vector may be a vector that is determined by de-identifying the identification vector indicating personal information and a relationship between nodes (or simply referred to as a node relationship hereinafter) among the input feature vectors of the identification data.

The de-identification vector may be a result obtained when the data de-identification apparatus initially learns the identification data using the GNN model. For example, the de-identification vector may be determined through an initial operation with an input matrix generated based on the identification data, and an initial matrix and a weight matrix of the GNN model.

The de-identification vector may be a vector that is generated by the data de-identification apparatus from an input feature vector associated with personal information that a user desires to de-identify among the input feature vectors. The de-identification vector may be generated as an operation or computation is performed on the input feature vector associated with the personal information along with the initial matrix and the weight matrix of the GNN model. Thus, the personal information included in the de-identification vector may be de-identified.

However, the de-identification vector may be the result of the initial learning or training, and thus a correlation between sets of data of the identification data may be applied thereto. As the training by the data de-identification apparatus progresses, the training may be performed in a way that minimizes output feature vectors, and thus the correlation between sets of data of the identification data may be disregarded. Thus, the data de-identification apparatus may classify the output feature vectors using the de-identification vector.

For example, the training by the data de-identification apparatus may be performed through Equation 1 below.

H⁽ⁱ⁺¹⁾=f*H⁽ⁱ⁾,A) [symbol] [Equation 1]

In Equation 1 above, H denotes each network layer of a GNN model. Each network layer may be of a form of a matrix. H⁽⁰⁾ denotes an input matrix, and A denotes an initial matrix. That is, by inputting the input matrix and the initial matrix to a function f, a first layer H⁽¹⁾ may be determined. H⁽¹⁾ may include a de-identification vector. The GNN model may include L network layers, for example.

The function f may be represented in detail as Equation 2 below.

f(H(i),A)=σ(A·H(i)·W(i)) [Equation 2]

In Equation 2 above, σ denotes a nonlinear activation function such as a rectified linear unit (ReLU). W denotes a weight matrix. W⁽⁰⁾ may be determined to have a size of D×F corresponding to the number D of input feature vectors and the number F of output feature vectors. At an i-th layer after an initial layer, W⁽ⁱ⁺¹⁾ may be generated to have a size of F⁽ⁱ⁾×F⁽ⁱ⁺¹⁾. Thus, a size of an output feature vector may be determined based on a second dimension size F^{(L)} of a weight vector W^{(L-1)}.

That is, the data de-identification apparatus may determine a subsequent layer H⁽¹⁾ of the GNN model by operating or computing the initial matrix A, the input matrix H⁽⁰⁾, and the weight matrix W using the nonlinear activation function. Subsequently, the data de-identification apparatus may keep training the GNN model through Equation 1. Finally, the data de-identification apparatus may extract H^{(L)} as a final training result. H^{(L)} may indicate an output matrix including an output feature vector.

The data de-identification apparatus may update the weight matrix of the GNN model to minimize the output feature vector. That is, by grouping similar or same values among respective values of nodes included in an input feature vector, an output feature vector may be extracted.

For example, the data de-identification apparatus may train the GNN model such that values in a certain range among the values of the nodes included in the input feature vector are unified into a single value, while adjusting the values of the nodes included in the input feature vector to be minimum.

Subsequently, the data de-identification apparatus may substitute, with the de-identification vector determined through the initial training of the GNN model, the output feature vector corresponding to the input feature vector indicating the personal information and the node relationship among the input feature vectors. For this, the data de-identification apparatus may match the input feature vector that continuously changes in an intermediate training step to a previous training result, thereby continuously tracking it.

Although the personal information is de-identified, the de-identification vector may reflect therein a node correlation, and thus the output matrix substituted with the de-identification vector may also reflect therein the node correlation. That is, to apply the node correlation, the data de-identification apparatus may classify values in the output feature vector based on the de-identification vector.

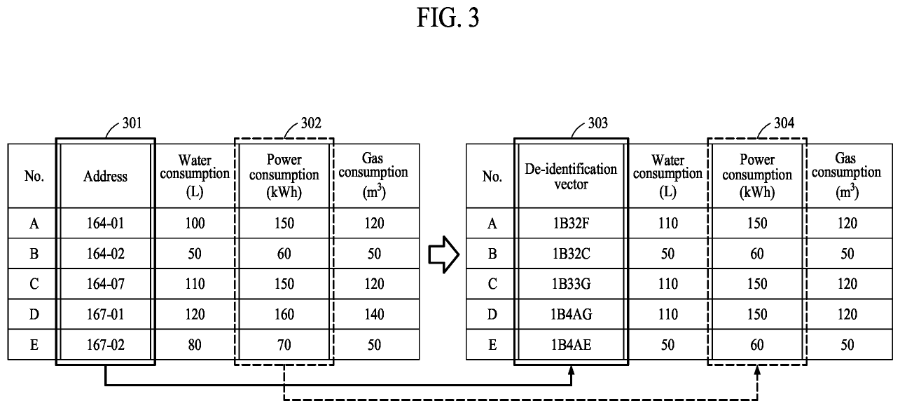

FIG. 3 is a diagram illustrating an example of extracting an output feature vector using an input feature vector according to an example embodiment.

A left table of FIG. 3 illustrates an input matrix including five nodes (e.g., A, B, C, D, and E), and each of the nodes indicates a household. In the example of FIG. 3, input feature vectors include an address, a water consumption amount, a power consumption amount, and a gas consumption amount of each household. Among the input feature vectors, an input feature vector 301 indicating personal information and a node relationship may include respective addresses of the nodes.

A right table of FIG. 3 illustrates an output matrix in which values in an address field are substituted with a de-identification vector 303. In the example of FIG. 3, values in the input feature vectors in the left table of FIG. 3 may be grouped to be extracted as values in output feature vectors in the right table of FIG. 3.

For example, as illustrated, an input feature vector 302 associated with a power consumption amount in the left table of FIG. 3 includes values, for example, 60, 70, 150, and 160. In this example, a data de-identification apparatus may group the values through a GNN model, and thus an output feature vector 304 includes only the values, for example, 60 and 150, in the right table of FIG. 3.

Through the de-identification vector 303, the addresses included in the input feature vector 301 may not be identifiable. However, in the de-identification vector 303, addresses that are close to each other may have similar values determined through training.

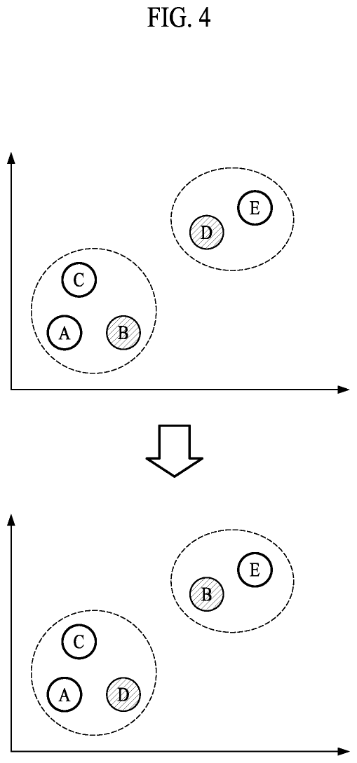

FIG. 4 is a diagram illustrating an example of classifying values in an output feature vector using a de-identification vector to which a correlation is applied according to an example embodiment.

FIG. 4 illustrates an example of classifying nodes according to an example embodiment. An upper portion of FIG. 4 illustrates node classification based on a result of initial training of a GNN model.

Referring to the upper portion of FIG. 4, because it may not be easy to group input feature vectors associated with a water consumption amount, a power consumption amount, and a gas consumption amount from the result of the initial training of the GNN model, a data de-identification apparatus may classify nodes through a de-identification vector determined by initially learning an input feature vector associated with an address. As illustrated in the upper portion of FIG. 4, nodes A, B, and C with addresses close to each other may be classified into a same group, and nodes D and E with addresses close to each other may be classified into a same group. That is, a node correlation, for example, an address, may be applied as illustrated in the upper portion of FIG. 4.

A lower portion of FIG. 4 illustrates node classification based on a result of final training of the GNN model. As the result of the final training, nodes A, C, and D which have a water consumption amount of 110, a power consumption amount of 150, and a gas consumption amount of 120 may be grouped together. In addition, as the result of the final training, nodes B and E which have a water consumption amount of 50, a power consumption amount of 60, and a gas consumption amount of 50 may be grouped together.

Since personal information such as an address and a node relationship are not applied to the nodes classified through the result of the final training, the data de-identification apparatus may apply the personal information and the node relationship to the result of the final training using the de-identification vector.

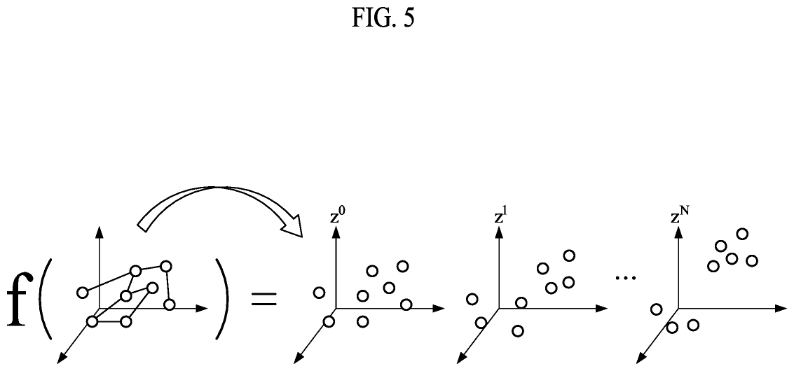

FIG. 5 is a diagram illustrating an example of grouping nodes of a GNN model according to an example embodiment.

A left portion (or term) of FIG. 5 illustrates an initial graph generated from identification data by a data de-identification apparatus. The initial graph includes nodes and edges connecting the nodes.

A right portion (or term) of FIG. 5 illustrates how nodes are classified while the data de-identification apparatus is performing training by performing an operation using, as a function, an initial matrix corresponding to the initial graph, an input matrix, and a weight matrix of the GNN model. A direction of an arrow indicates a direction in which the training progresses. As the training progresses, nodes having similar values corresponding to an input feature vector may be grouped together.

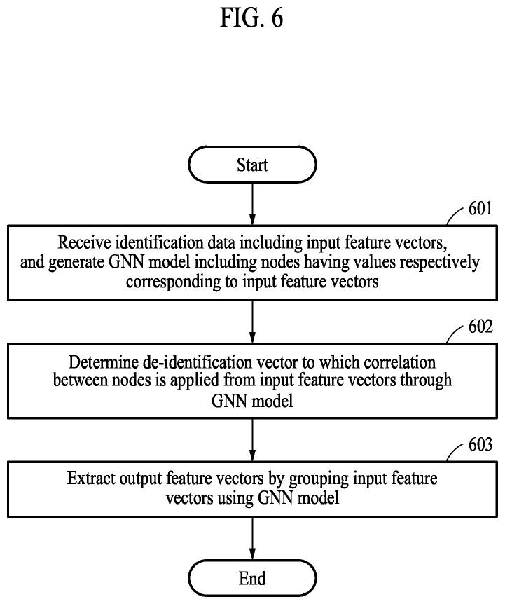

FIG. 6 is a flowchart illustrating an example of a data de-identification method according to an example embodiment.

Referring to FIG. 6, in operation 601, a data de-identification apparatus receives identification data including a plurality of input feature vectors, and generates a GNN model including a plurality of nodes each having a value corresponding to each of the input feature vectors.

For example, the data de-identification apparatus may generate an edge between the nodes based on a correlation between the nodes from the identification data. The data de-identification apparatus may determine the GNN model including an initial matrix corresponding to an initial graph including the nodes generated based on the identification data and the edge to which the correlation between the nodes is applied, and including a weight matrix.

Thus, the initial matrix may include information associated with the correlation between the nodes. The weight matrix may be generated as many as the number of layers of the GNN model.

In operation 602, the data de-identification apparatus determines a de-identification vector to which the correlation between the nodes is applied from the input feature vectors through the GNN model.

For example, the data de-identification apparatus may generate the de-identification vector by initially performing an operation on an input feature vector that includes personal information and a node correlation among the input feature vectors, along with the initial matrix and the weight matrix of the GNN model.

In operation 603, the data de-identification apparatus extracts an output feature vector by grouping values in each of the input feature vectors using the GNN model. For example, the data de-identification apparatus may generate an output feature vector by grouping values respectively corresponding to the nodes in each of the input feature vectors by performing an operation on the input feature vectors with the initial matrix and the weight matrix of the GNN model.

In this example, the data de-identification apparatus may update the output feature vector by performing an operation again on the output feature vector that is extracted by performing the operation on each of the input feature vectors with the initial matrix and the weight matrix of the GNN model, using the initial matrix and the weight matrix. That is, by updating the output feature vector the number of times corresponding to the layers of the GNN model, a final output feature vector may be determined.

The data de-identification apparatus may update the weight matrix included in the GNN model to minimize the number of groups in a process of grouping the values in each of the input feature vectors.

The data de-identification apparatus may substitute one of final output feature vectors with a de-identification vector determined through an initial operation. Here, the final output feature vector among the final output feature vectors may be an output feature vector obtained by performing an operation on an input feature vector associated with personal information.

The data de-identification apparatus may classify the nodes using the substituted output feature vector. For example, the data de-identification apparatus may classify the nodes based on the de-identification vector, or classify the nodes using a final output feature vector obtained through training.

Thus, through the data de-identification apparatus described herein, it is possible to analyze identification data to which a correlation between sets of data is applied, while de-identifying the identification data.

According to an example embodiment described herein, it is possible to analyze a correlation between sets of data by providing a de-identification vector such that an analysis of de-identified data is performed in a similar way as an analysis of a correlation between sets of previous identification (or identified) data.

According to an example embodiment described herein, it is possible to protect personal information required to be protected when distributing data by de-identifying personal information included in identification data.

The units described herein may be implemented using hardware components and software components. For example, the hardware components may include microphones, amplifiers, band-pass filters, audio to digital convertors, non-transitory computer memory and processing devices. A processing device may be implemented using one or more general-purpose or special purpose computers, such as, for example, a processor, a controller and an arithmetic logic unit (ALU), a digital signal processor, a microcomputer, a field programmable gate array (FPGA), a programmable logic unit (PLU), a microprocessor or any other device capable of responding to and executing instructions in a defined manner. The processing device may run an operating system (OS) and one or more software applications that run on the OS. The processing device also may access, store, manipulate, process, and create data in response to execution of the software. For purpose of simplicity, the description of a processing device is used as singular; however, one skilled in the art will appreciated that a processing device may include multiple processing elements and multiple types of processing elements. For example, a processing device may include multiple processors or a processor and a controller. In addition, different processing configurations are possible, such a parallel processors.

The software may include a computer program, a piece of code, an instruction, or some combination thereof, to independently or collectively instruct or configure the processing device to operate as desired. Software and data may be embodied permanently or temporarily in any type of machine, component, physical or virtual equipment, computer storage medium or device, or in a propagated signal wave capable of providing instructions or data to or being interpreted by the processing device. The software also may be distributed over network coupled computer systems so that the software is stored and executed in a distributed fashion. The software and data may be stored by one or more non-transitory computer readable recording mediums. The non-transitory computer readable recording medium may include any data storage device that can store data which can be thereafter read by a computer system or processing device.

The methods according to the above-described example embodiments may be recorded in non-transitory computer-readable media including program instructions to implement various operations of the above-described example embodiments. The media may also include, alone or in combination with the program instructions, data files, data structures, and the like. The program instructions recorded on the media may be those specially designed and constructed for the purposes of example embodiments, or they may be of the kind well-known and available to those having skill in the computer software arts. Examples of non-transitory computer-readable media include magnetic media such as hard disks, floppy disks, and magnetic tape; optical media such as CD-ROM discs, DVDs, and/or Blue-ray discs; magneto-optical media such as optical discs; and hardware devices that are specially configured to store and perform program instructions, such as read-only memory (ROM), random access memory (RAM), flash memory (e.g., USB flash drives, memory cards, memory sticks, etc.), and the like. Examples of program instructions include both machine code, such as produced by a compiler, and files containing higher level code that may be executed by the computer using an interpreter. The above-described devices may be configured to act as one or more software modules in order to perform the operations of the above-described example embodiments, or vice versa.

While this disclosure includes specific examples, it will be apparent to one of ordinary skill in the art that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents.

Therefore, the scope of the disclosure is defined not by the detailed description, but by the claims and their equivalents, and all variations within the scope of the claims and their equivalents are to be construed as being included in the disclosure.

What is claimed is:

1. A data de-identification method comprising:
receiving identification data including a plurality of input feature vectors, and generating a graph neural network (GNN) model including a plurality of nodes each having a value corresponding to each of the input feature vectors;
determining a de-identification vector to which a correlation between the nodes is applied from the input feature vectors through the GNN model; and
extracting an output feature vector by grouping values in each of the input feature vectors using the GNN model.

2. The data de-identification method of claim 1, wherein the generating of the GNN model comprises:
determining the GNN model including an initial matrix corresponding to an initial graph including nodes generated based on the identification data and an edge to which a correlation between the nodes is applied, and including a weight matrix.

3. The data de-identification method of claim 2, wherein the determining of the de-identification vector comprises:
generating the de-identification vector by performing an operation on an input feature vector including personal information or the correlation between the nodes among the input feature vectors, with the initial matrix and the weight matrix of the GNN model.

4. The data de-identification method of claim 2, wherein the extracting of the output feature vector comprises:
generating the output feature vector by grouping the values respectively corresponding to the nodes in each of the input feature vectors by performing an operation on the input feature vectors with the initial matrix and the weight matrix of the GNN model.

5. The data de-identification method of claim 1, further comprising:
substituting the output feature vector with the de-identification vector to which the correlation between the nodes is applied.

6. The data de-identification method of claim 5, further comprising:
classifying the nodes based on the substituted output feature vector.

7. The data de-identification method of claim 1, further comprising:
updating a weight matrix included in the GNN model to minimize the number of groups in the grouping of the values in each of the input feature vectors.

8. A data de-identification apparatus comprising:
a processor,
wherein the processor is configured to:
receive identification data including a plurality of input feature vectors;
generate a graph neural network (GNN) model including a plurality of nodes each having a value corresponding to each of the input feature values;
determine a de-identification vector to which a correlation between the nodes is applied from the input feature vectors through the GNN model; and
extract an output feature vector by grouping values in each of the input feature vectors using the GNN model.

9. The data de-identification apparatus of claim 8, wherein the processor is configured to:
determine the GNN model including an initial matrix corresponding to an initial graph including nodes generated based on the identification data and an edge to which a correlation between the nodes is applied, and including a weight matrix.

10. The data de-identification apparatus of claim 9, wherein the processor is configured to:
generate the de-identification vector by performing an operation on an input feature vector including personal information or the correlation between the nodes among the input feature vectors, with the initial matrix and the weight matrix of the GNN model.

11. The data de-identification apparatus of claim 9, wherein the processor is configured to:
generate the output feature vector by grouping the values respectively corresponding to the nodes in each of the input feature vectors by performing an operation on the input feature vectors with the initial matrix and the weight matrix of the GNN model.

12. The data de-identification apparatus of claim 8, wherein the processor is configured to:
substitute the output feature vector with the de-identification vector to which the correlation between the nodes is applied.

13. The data de-identification apparatus of claim 12, wherein the processor is configured to:
classify the nodes based on the substituted output feature vector.

14. The data de-identification apparatus of claim 8, wherein the processor is configured to:
update a weight matrix included in the GNN model to minimize the number of groups in the grouping of the values in each of the input feature vectors.
